(19) United States
(12) Patent Application Publication
(10) Pub. No.: US 2016/0295839 A1
(43) Pub. Date: Oct. 13, 2016

(54) ENCLOSURE FOR A HOUSEHOLD PET

(71) Applicant: AvianWeb, LLC, Mims, FL (US)

(72) Inventor: Sibylle Johnson, Mims, FL (US)

(21) Appl. No.: 15/094,958

(22) Filed: Apr. 8, 2016

Related U.S. Application Data
(60) Provisional application No. 62/145,437, filed on Apr. 9, 2015.

(51) Int. Cl. A01K 31/00; A01K 1/00

(52) U.S. Cl. CPC A01K 31/00; A01K 1/00

(57) ABSTRACT

An enclosure for a household pet is described that has a top portion and a bottom portion. The enclosure can have a plurality of substantially vertical sides extending between the bottom portion and the top portion to form an enclosure for a household pet. At least a first side and a second side of the plurality of substantially vertical sides can be configured to be disposed adjacent to two sides of a larger enclosure. At least a third side of the plurality of substantially vertical sides configured to be disposed away from the sides of the larger enclosure. The third side can have an aperture to allow access into the enclosure by a household pet. The enclosure can have at least one connecting device configured to attach the enclosure for the household pet to the larger enclosure.

### CROSS-REFERENCE TO RELATED APPLICATIONS

This application claims the benefit of U.S. Provisional Patent Application No. 62/145,437, titled “An Enclosure for A Household Pet,” and filed on Apr. 9, 2015, the disclosure of which is incorporated herein by reference in its entirety.

### TECHNICAL FIELD

The subject matter described herein relates to enclosures for household pets.

### BACKGROUND

Owners of household pets provide the household pets with bedding and sleeping compartments for the household pets to sleep and rest in. Some household pets are best kept inside cages or boxes. Typically, bedding is provided to the household pet within the cages or boxes. When the bedding is disposed on the bottom of the cage or box it becomes soiled. In addition, some household pets do not like their sleeping areas to be low to the ground or at the bottom of a cage.

### SUMMARY

In one aspect, an enclosure for a household pet is provided. Such household pets may include birds/parrots, rats, mice, flying squirrels, sugar gliders, Guinea pigs, gerbils and chinchillas and/or other household pets. The enclosure may comprise a plurality of substantially vertical sides. The plurality of substantially vertical sides may comprise two sides configured to be disposed adjacent to different sides of a larger enclosure and a third side configured to be disposed away from the sides of a larger enclosure. The third side may include an aperture. The aperture may be configured to facilitate access to the enclosure by a household pet.

The enclosure may include a top side and a bottom side. The top side and the bottom side may connect with top and bottom portions, respectively, of the plurality of substantially virtual sides of the enclosure. In some implementations, the top side and the bottom side may be substantially triangular.

The substantially vertical side portions may be formed from fabric, plastics, glass, metals or wood, and/or other materials.

The top side and the bottom side may be formed from fabric, plastics, glass, metals or wood, and/or other materials.

The enclosure may comprise a plush internal surface. The plush internal surface may be formed from fleece, cotton, silk, plush fabric and/or other materials.1

The enclosure may comprise a plurality of connection mechanisms. The plurality of connection mechanisms may be configured to connect the enclosure to the larger enclosure.

The aperture disposed in third side of the enclosure may be off-set from the center of the third side of the enclosure. This will allow animals to self-regulate their heat. If they get cold, they can hide away from the aperture where they are protected from cold drafts.

The aperture may include a closing mechanism configured to facilitate closing of the aperture.

Implementations of the current subject matter can provide one or more advantages. For example, an enclosure having one or more of the presently disclosed features may facilitate the enclosure to be disposed within a corner of a larger enclosure, such as a cage or a hut. Disposing the enclosure within the corner of a larger enclosure allows a greater volume of the larger enclosure to be utilized.

A cuboid enclosure disposed within the corner of a larger enclosure, such that two sides of the cuboid enclosure were adjacent two sides of the larger enclosure, would typically have an opening, for access by a household pet, adjacent the sides of the larger enclosure. Such an opening would cause there to be blind spots within the larger enclosure for the household pet. Having blind spots within the larger enclosure for the household pet may raise anxiety in the household pet.

An enclosure having one or more features consistent with this disclosure would include an opening, or aperture, that faces substantially inward of the larger enclosure, allowing the household pet to view the majority of the larger enclosure from the opening. Consequently, an enclosure having one or more features consistent with this disclosure would both utilize corners of a larger enclosure while also allowing the household pet to view most of the larger enclosure, thereby reducing its anxiety.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes only, it should be readily understood that such features are not intended to be limiting. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 is an illustration of an enclosure having one or more features consistent with implementations of the current subject matter;

FIG. 2 is an illustration of a cage showing multiple location options for one or more enclosures having one or more features consistent with implementations of the current subject matter;

FIG. 3 is an illustration of an enclosure having one or more features consistent with implementations of the current subject matter; and,

FIG. 4 is an illustration of an enclosure having one or more features consistent with implementations of the current subject matter.

### DETAILED DESCRIPTION

When bedding or a sleeping structure is provided inside that cage or enclosure it is typically not specifically designed to fit within the corners of the cage. The corner but basically provides the same advantages as a “corner desk” would give to a room with special spatial challenges. The same challenges often exist in cages. For birds, for example, the upper space of a cage is typically filled with toys, ladders and other furnishings. So the ability to place the space-optimizing corner but at any level (wherever there is space) is a significant benefit. As far as pets are concerned that live closer to the ground, they benefit from as much space as possible on the ground, so in this case, it is a benefit to be able to keep the corner but somewhat elevated from the ground (at a level that will allow a pet to climb in and exit safely, and yet still allows a pet to enjoy the space below for other activities (running around / exercising). This will also help with hygiene issues as it keeps the corner but separated from waste matter, such as urine or feces that typically accumulates on the ground. Therefore, there is a need to provide household pets with an enclosure that is raised from the bottom of their cage; and one that optimally utilizes currently wasted space within a cage. Any square but can be pushed into the corner, but typically this will require a but to be attached at four corners and that generally means it needs to be fixed to the ceiling of an animal cage. The presently disclosed enclosure only needs to be attached at three corners, which makes it possible for this item to be attached to the ceiling or the sides of the cage—so that it can literally be situated at any point—from the bottom of the cage to the very top. The other advantage of the corner but is the space-saving aspect. It is more likely to fit into most animal cages, which tend to be rather compact leaving very little space for the animal to exercise and for placing any cage accessories such as food and water dishes, toys and other furnishings. A corner but is designed for a space that typically is not used very well (corners)—so it won't take up a significant space in a cage, and yet provide a safe and warm place for sleeping or resting. The corner but also provides a pet with an unobstructed view of its entire enclosure. As small animals are generally prey animal and blind spots within their space can result in anxiety.

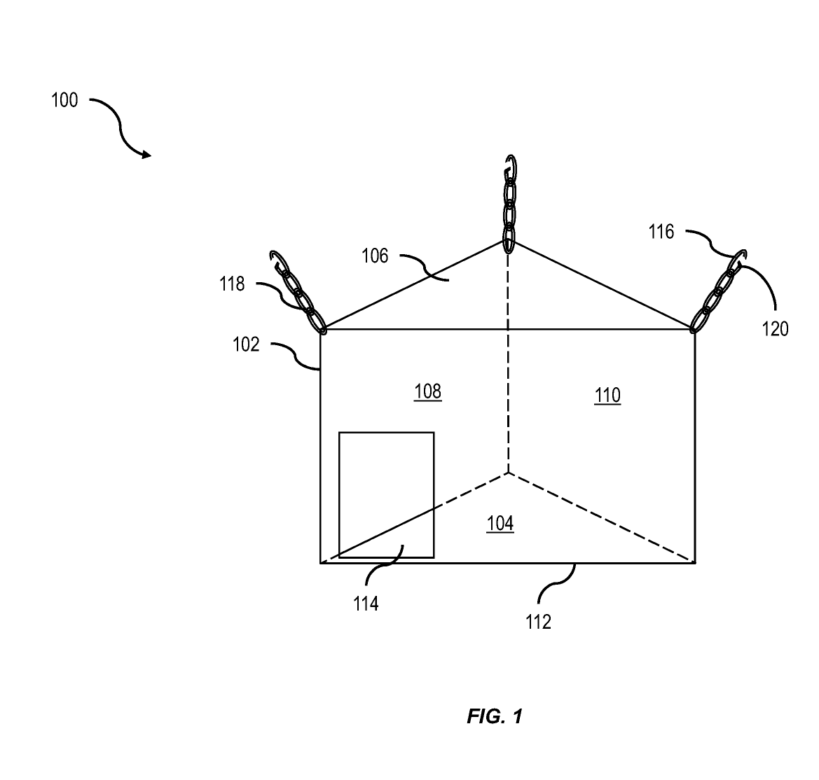

FIG. 1 is an illustration of a system 100 having an enclosure 102 that has one or more features consistent with implementations of the current subject matter. The enclosure 102 can be configured to be disposed within a larger enclosure for a household pet. The enclosure 102 can be configured to be disposed within a corner of the larger enclosure. Household pets contemplated for the described enclosure include birds/parrots, rats, mice, flying squirrels, sugar gliders, Guinea pigs, gerbils and chinchillas, and/or other similar household pets.

The enclosure 102 can include a top portion 102 and a bottom portion 104. The bottom portion 104 can be configured to inhibit liquid substances, or the like, from transgressing into and/or out of the enclosure 102. For example, the enclosure 102 can be placed within a larger cage. In some use cases the enclosure 102 can be placed on the floor of the cage. Liquids, such as urine, feces, water, or the like, may accumulate on the cage floor. The bottom portion 104 can be configured to inhibit the liquids from entering the enclosure 102 through the bottom portion 104.

The enclosure 102 can include a plurality of substantially vertical sides 108, 110, 112. The plurality of substantially vertical sides 108, 110, 112 can be configured to extend between the bottom portion 104 and the top portion 106 of the enclosure 102. The plurality of substantially vertical sides 108, 110, 112, the bottom portion 104 and the top portion 106 can form an enclosure for a household pet.

The bottom portion 104 and the top portion 106 can be substantially triangular in shape. Together, the bottom portion 104, top portion 106 and the plurality of substantially vertical sides 108, 110, 112, can form an enclosure that is substantially prismatic.

In some variations, the plurality of substantially vertical sides 108, 110, 112, the bottom portion 104, and the top portion 106, can be formed from a single material. The material can include a material configured to provide a comfortable environment in which a household pet may desire to sleep.

In some variations, the plurality of substantially vertical sides 108, 110, 112, the bottom portion 104, and the top portion 106, can be formed from a plurality of materials formed in layers. The plurality of substantially vertical sides 108, 110, 112, the bottom portion 104, and the top portion 106, that are formed from a plurality of materials formed in layers can include an inner layer and an outer layer. The inner layer can be formed from a plush material configured to enclose around the household pet. This can keep the household pet cozy, and feel warm and safe when inside the enclosure for a household pet. The outer layer can be formed from a material configured to provide support for the enclosure 102. The outer layer can be formed from a water-resistant material, facilitating easy cleaning of the outside of the enclosure 102. The outer layer can be formed from a stain-resistant material.

In some variations, the top portion 106 of the enclosure 102 can be formed from a solid material or substantially rigid material. The top portion 106 having a solid or substantially rigid material allowing the enclosure 102 to substantially maintain its shape when there are limited attachment devices used to attach the enclosure 102 to a larger enclosure.

Materials used for making the enclosure can include polymer-based materials, fleece-based materials, cotton-based materials, wool-based materials, silk-based materials, cellulose-based materials, or the like. In some variations, wood-based materials, plastic-based materials, metal-based materials, or the like, can be used to make the enclosure. In some variations, the bottom portion 104, top portion 106 and the substantially vertical sides 108, 110, 112 can be formed from a contiguous material. In some variations, the substantially vertical sides 108, 110, 112 can be formed from a contiguous material. In some variations, one or more components of the enclosure 102 can be formed from a material having a substantially water resistant and/or stain resistant outer surface and a plush soft inner surface.

In some variations, the material forming the enclosure can be formed from an easy-care material, such as materials that are machine-washable.

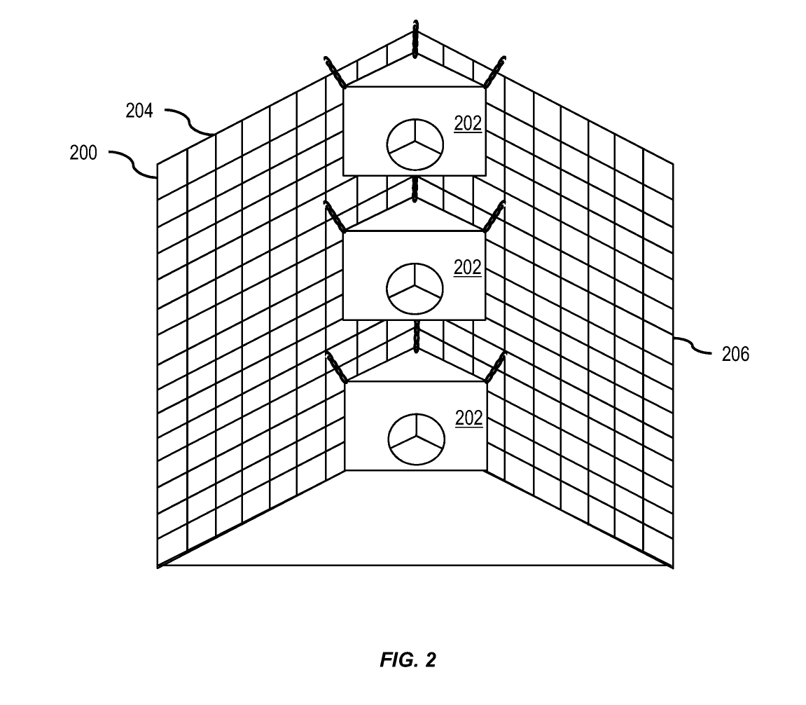

FIG. 2 is an illustration of a larger enclosure 200 showing multiple location options for one or more enclosures 202 having one or more features consistent with implementations of the current subject matter. The larger enclosure 200 can include two sides 204, 206. In some variations, the plurality of substantially vertical sides of the enclosure 202 can include at least a first side 108 and a second side 110. The at least a first side 108 and the at least a second side 110 can be configured to be disposed adjacent to the two sides 204, 206 of the larger enclosure 200. In this configuration, the enclosure 202 can be configured to be disposed within a corner of the larger enclosure 200.

In some variations, the plurality of substantially vertical sides of the enclosure 202 can include at least a third side 112. The at least a third side 112 can be configured to be disposed away from the two sides 204, 206 of the larger enclosure 200.

The enclosure 202 can be configured to be vertically disposed at any location within the larger enclosure 200. FIG. 2 illustrates examples of the locations of one or more enclosures 202.

Referring again to FIG. 1, the at least a third side 112 can include an aperture 114. The aperture 114 can be configured to allow access into the enclosure 102 by a household pet. As illustrated in FIG. 1, the aperture 114 can be off-set from the center of the third side 112 of the enclosure 102. An off-set aperture 114 can facilitate animals inside the enclosure 102 to self-regulate their heat and their visibility. If the animals get cold, they can move away from the aperture 114 where they are protected from drafts. If the animals get warm, they can move toward the aperture 114 to receive the benefit of drafts.

In some variations, the aperture 114 may include a closure configured to facilitate closing of the aperture. The closure can be a zipper, a plug, a door, or the like. Closing the aperture 114 can provide multiple benefits including keeping the animal inside the enclosure 102 when maintenance or other work must be performed on the larger enclosure, or keeping the animal from entering the enclosure when the animal needs to be encouraged to interact with the rest of the larger enclosure in which the enclosure 102 resides.

In some variations, the aperture 114 can have a polygonal shape, a round shape, or the like.

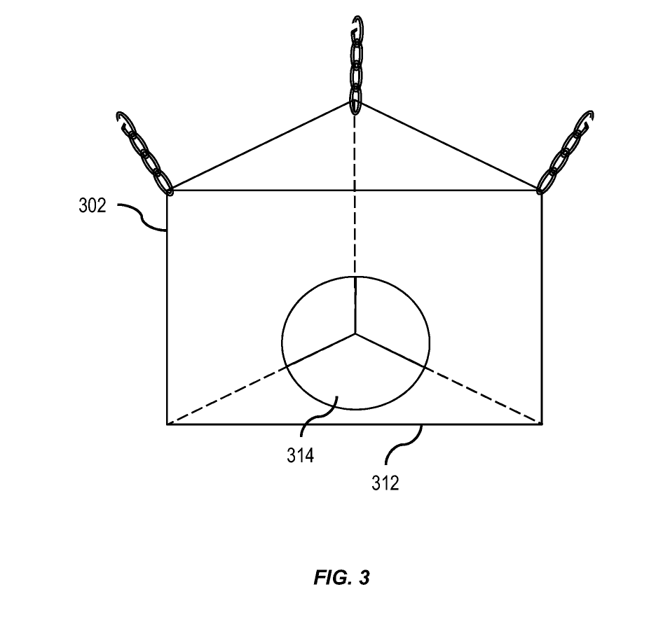

FIG. 3 is an illustration of an enclosure 302 having one or more features consistent with implementations of the current subject matter. The enclosure 302 can include an aperture 314. In some variations, the aperture 314 can have a round shape, a polygonal shape, or the like. In some variations, the aperture 314 can be substantially centered in a front side 312 of the enclosure 302. The aperture 314 can be centered horizontally and/or vertically in the front side 312 of the enclosure 302.

Referring again to FIG. 1, the enclosure 102 can include at least one connecting device 116. The at least one connecting device 116 can be configured to attach the enclosure 102 for the household pet to a larger enclosure. The at least one connecting device 116 can include one or more of ties, d-rings, hooks, spring buckles, quick links, Snap Hooks, Carabineers, Velcro fasteners or the like.

In some variations, a connecting device 116 can include a linking system 118. The linking system 118 can be disposed between an engagement end 120 of the connecting device 116 and the enclosure 102. The linking system 118 can include a rope, chain, string, or the like.

In some variations, the connecting device 116 can be configured to attach the enclosure to the sides of a larger enclosure, for example, a cage, or to the roof of a larger enclosure.

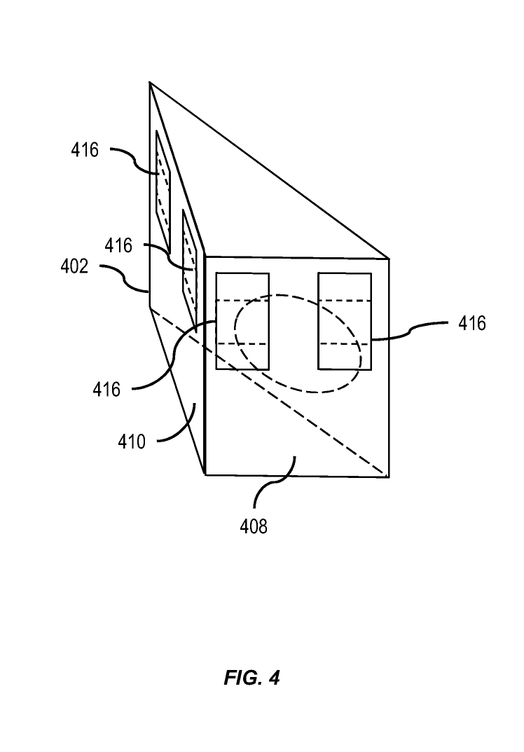

FIG. 4 is an illustration of an enclosure 402 having one or more features consistent with implementations of the current subject matter. The enclosure 402 can include fasteners 416. The fasteners 416 can be configured to attach to the bars of a cage. The fasteners 416 can include Velcro fasteners, for example. The fasteners 416 can be attached to at least a first side 408 and/or at least a second side 410 of the enclosure 402.

Implementations of the current subject matter can provide one or more advantages. For example, an enclosure having one or more of the presently disclosed features may facilitate the enclosure to be disposed within a corner of a larger enclosure, such as a cage or a hut. Disposing the enclosure within the corner of a larger enclosure allows a greater volume of the larger enclosure to be utilized.

A cuboid enclosure disposed within the corner of a larger enclosure, such that two sides of the cuboid enclosure were adjacent two sides of the larger enclosure, would typically have an opening, for access by a household pet, adjacent the sides of the larger enclosure. Such an opening would cause there to be blind spots within the larger enclosure for the household pet. Having blind spots within the larger enclosure for the household pet may raise anxiety in the household pet.

An enclosure having one or more features consistent with this disclosure would include an opening, or aperture, that faces substantially inward into the larger enclosure, allowing the household pet to view the majority of the larger enclosure from the opening. Consequently, an enclosure having one or more features consistent with this disclosure would both utilize corners of a larger enclosure while also allowing the household pet to view most of the larger enclosure, thereby reducing the household pet's anxiety.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes only, it should be readily understood that such features are not intended to be limiting. The claims that follow this disclosure are intended to define the scope of the protected subject matter.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. An enclosure for a household pet comprising:
a top portion and a bottom portion; and,
a plurality of substantially vertical sides extending between the bottom portion and the top portion to form an enclosure for a household pet, at least a first side and a second side of the plurality of substantially vertical sides configured to be disposed adjacent to two sides of a larger enclosure and at least a third side of the plurality of substantially vertical sides configured to be disposed away from the sides of the larger enclosure, the third side having an aperture to allow access into the enclosure by a household pet.

2. The enclosure for a household pet as in claim 1, wherein the household pet is a bird.

3. The enclosure for a household pet as in claim 1, wherein the aperture is round.

4. The enclosure for a household pet as in claim 1, wherein the aperture is a polygon.

5. The enclosure for a household pet as in claim 1, wherein the aperture is off-set from a center of the at least third side.

6. The enclosure for a household pet as in claim 1, wherein the aperture includes a closure.

7. The enclosure for a household pet as in claim 1, further comprising at least one connecting device configured to attach the enclosure for the household pet to the larger enclosure.

8. The enclosure for a household pet as in claim 5, wherein the connecting device includes a spring buckle.

9. The enclosure for a household pet as in claim 5, wherein the connecting device includes Velcro tags.

10. The enclosure for a household pet as in claim 1, further comprising a plush interior.

11. The enclosure for a household pet as in claim 10, wherein the plush interior is configured to drape around the household pet.

12. The enclosure for a household pet as in claim 1, wherein the enclosure is substantially prismatic.
